(19) United States
(12) Patent Application Publication
(10) Pub. No.: US 2012/0104964 A1
(43) Pub. Date: May 3, 2012

(54) LED DRIVER WITH PWM DIMMING AND METHOD THEREOF

(76) Inventor: Brent Hughes, Cumming, GA (US)

(21) Appl. No.: 12/913,699

(22) Filed: Oct. 27, 2010

(51) Int. Cl. H05B 37/02

(52) U.S. Cl. 315/291

(57) ABSTRACT

The present technology is generally related to LED drivers with PWM dimming. In one embodiment, a dimming signal is generated based on a pulsed input signal. The pulsed input signal is converted into at least one current signal to drive an LED. And the conversion is enable and disabled by the dimming signal.

### TECHNICAL FIELD

The present technology generally relates to electrical circuits, and more particularly, relates to light emitting diode (“LED”) drivers and associated methods thereof.

### BACKGROUND

LEDs have been widely used in various applications such as liquid crystal display (“LCD”) backlighting and general illumination because of their small sizes and energy efficiencies. In operation, LED drivers are needed to provide a regulated current signal to drive the LEDs. Pulse width modulation (“PWM”) dimming is often used in LED drivers to adjust the luminance of the LEDs. A PWM dimming signal controls the on and off of the LED drivers.

Typically, the PWM dimming signal is independent of an input signal to an LED. So at least three terminals are needed to achieve the PWM dimming, i.e., one for the input signal, one for dimming signal, and one for ground. However, in some retrofit applications such as in commercial refrigerators, only two terminals can be provided. Accordingly, techniques for providing PWM dimming with less than three (e.g., only two) terminal/wires may be needed.

### BRIEF DESCRIPTION OF THE DRAWINGS

FIG. 1 is a block diagram of an LED driver with PWM dimming in accordance with embodiments of the present technology.

FIG. 2 is a schematic circuit diagram illustrating an LED driver with PWM dimming in accordance with embodiments of the present technology.

FIG. 3 illustrates a waveform of the LED driver shown in FIG. 2 during operation.

FIG. 4 is a schematic circuit diagram illustrating an LED driver with PWM dimming in accordance with additional embodiments of the present technology.

FIG. 5 is a schematic circuit diagram of an integrated circuit suitable for use in the LED driver shown in FIG. 4.

FIG. 6 is a schematic circuit diagram illustrating an LED driver with PWM dimming in accordance with further embodiments of the present technology.

FIG. 7 is a flowchart illustrating a method of driving an LED with PWM dimming in accordance with embodiments of the present technology.

### DETAILED DESCRIPTION

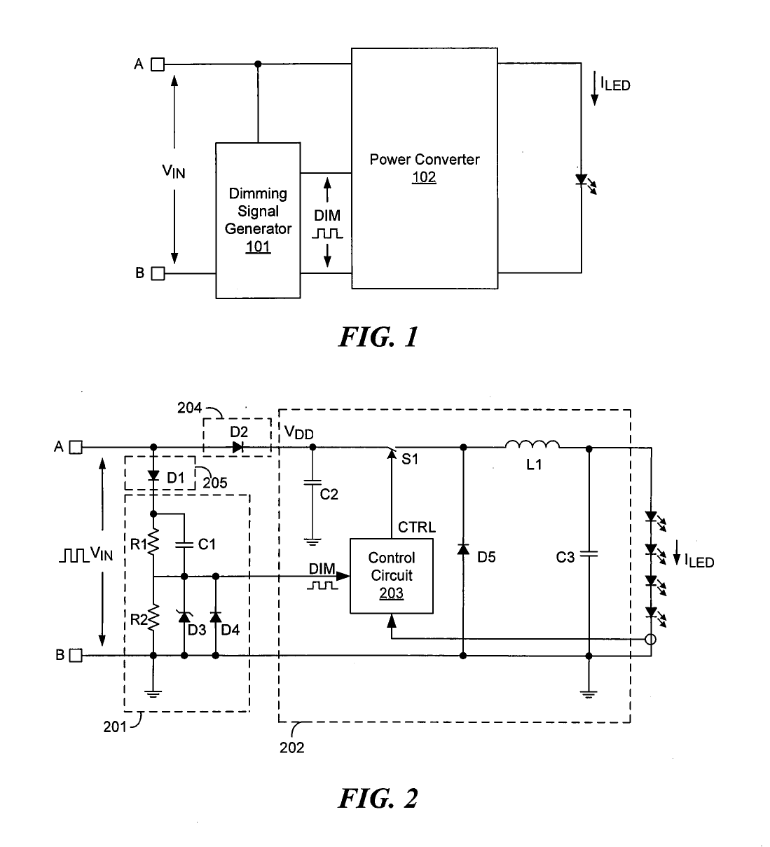

Several embodiments of the present technology are described below with reference to LED drivers with PWM dimming and associated methods of operation. Many specific details of certain embodiments are set forth in the following text to provide a thorough understanding of these embodiments. For example, in particular embodiments, the present technology is directed to an LED driver with PWM dimming with only two wires. The LED driver can include (1) two input terminals for receiving a pulsed input signal V_{IN} and (2) a dimming signal generator coupled to the two input terminals. The dimming signal generator can be configured to generate a dimming signal DIM based on the pulsed input signal V_{IN}. The LED driver can also include a power converter coupled to the two input terminals and to the dimming signal generator. The power converter is configured to convert the pulsed input signal V_{IN} into at least one current signal to drive an LED, and such a conversion is enable and disabled by the dimming signal DIM. Several other embodiments of the present technology can have configurations, components, and/or processes different from those described below. A person skilled in the relevant art, therefore, will appreciate that additional embodiments may be practiced without several of the details of the embodiments shown in FIGS. 1-7.

FIG. 1 is a block diagram of an LED driver with PWM dimming in accordance with additional embodiments of the present technology. As shown in FIG. 1, the LED driver can include two input terminals A, B for receiving a pulsed input signal V_{IN}. The LED driver also includes a dimming signal generator 101 and a power converter 102. The pulsed input signal V_{IN} includes a signal alternating between a certain voltage (e.g., +12 volts) and ground (zero), and the pulse width of the pulsed input signal V_{IN} is varied to control a dimming level.

The dimming signal generator 101 is electrically coupled to the two input terminals A and B to receive the pulsed input signal V_{IN} and to generate a dimming signal DIM based thereon. The frequency and pulse width of the dimming signal DIM is related to those of the pulsed input signal V_{IN}. In one embodiment, the dimming signal generator 101 comprises a resistor divider. Thus, the dimming signal DIM is a PWM signal with a pulse width and a frequency generally similar to those of the pulsed input signal V_{IN}. And the dimming signal DIM is synchronous with the pulsed input signal V_{IN}.

The power converter 102 is electrically coupled to the two input terminals A and B and the dimming signal generator 101 to receive the pulsed input signal V_{IN} and the dimming signal DIM. The power converter 102 converts the pulsed input signal V_{IN} into a current signal I_{LED} to drive the LED, and the conversion is enabled or disabled by the dimming signal DIM. Because the dimming signal DIM is generated based on the pulsed input signal V_{IN}, only two wires are needed to realize PWM dimming.

The power converter 102 may be configured as Buck, Boost, Buck-Boost, Flyback, and/or in other suitable DC/DC topology. And various control schemes such as peak current control, off time control and quasi-resonant control may be used. In certain embodiments, multiple LEDs may be serially connected to form an LED string, and the power converter 101 may be used to drive one or more of such LED strings.

The lower limit of the dimming frequency is believed to be approximately 120 Hz, below which human eyes may no longer blend the pulses of light into a perceived continuous light. The upper limit may be determined by a required minimum contrast ratio. In one embodiment, the power converter 102 operates normally when the dimming signal DIM is high (or low for active low input), and is shut down when the dimming signal DIM is low (or high for active low input). In other embodiments, the power converter 102 may operate based on other suitable logic values of the dimming signal DIM.

FIG. 2 is a schematic circuit diagram illustrating an LED driver with PWM dimming in accordance with embodiments of the present technology. As shown in FIG. 2, the LED driver includes a dimming signal generator 201 and a power converter 202. The dimming signal generator 201 comprises a resistor divider including resistors R1 and R2. The pulse width and frequency of the dimming signal DIM are generally similar to those of the pulsed input signal V_{IN}. In one embodiment, a capacitor C1 is electrically connected to the resistor R1 in parallel, for improving sensitivity of the dimming signal generator 201 to the edge of the pulsed input signal V_{IN}. As a result, the dimming of the LED driver may be generally unaffected by the slew rate of the pulsed input signal V_{IN}.

In one embodiment, a diode D3 (e.g., a Zener diode) and a diode D4 (e.g., a Schottky diode) may be electrically connected to the resistor R2 in parallel to clamp and square up the dimming signal DIM. The maximum voltage of the dimming signal DIM is believed to be the breakdown voltage of the diode D3, and the minimum voltage is generally −0.3V which is determined by the conduction voltage of the diode D4.

In the illustrated embodiment, the power converter 202 is configured in the Buck topology, and is configured to drive four serially connected LEDs. The power converter 202 comprises an input capacitor C2, a switch S1, a diode D5, an inductor L1, an output capacitor C3, and a control circuit 203. The diode D5 may be replaced by a synchronous switch (not shown) in certain embodiments. The current I_{LED} flowing through the LEDs is fed back to the control circuit 203 to control the on and off of the switch S1. The control circuit 203 operates normally when the dimming signal DIM is high, and turns off the switch S1 when the dimming signal DIM is low. Such control function can be realized by coupling a single AND gate to the gate of the switch S1, and/or changing the reference used to regulate the current I_{LED}. In other embodiments, the power converter 202 can be configured in other suitable topologies.

In most retrofit applications, polarity protection may be needed because the wiring is not always color coded. In one embodiment, a first polarity protection circuit 204 may be electrically coupled between the input terminals and the power converter 202, and a second polarity protection circuit 205 may be electrically coupled between the input terminals and the dimming signal generator 201. In other applications, at least one of the polarity protection circuits 204 and 205 may be omitted.

In one embodiment, the first polarity protection circuit 204 comprises a diode D2 electrically coupled between the input terminal A and the input capacitor C2, and the second polarity protection circuit 205 comprises a diode D1 electrically coupled between the input terminal A and the resistor R1. If the wires are connected in error, i.e., the voltage of the terminal B is higher than that of the terminal A, no current is flowing through the input terminals. Furthermore, when the pulsed input signal V_{IN} is low, the capacitor C2 is not discharged through the input terminals. And because the dimming signal DIM is also low, the power converter 202 is disabled and the load of the capacitor C2 is very low. As such, it is believed that a substantial portion, if not all, of the AC component may be removed from the input voltage V_{DD} of the power converter 202.

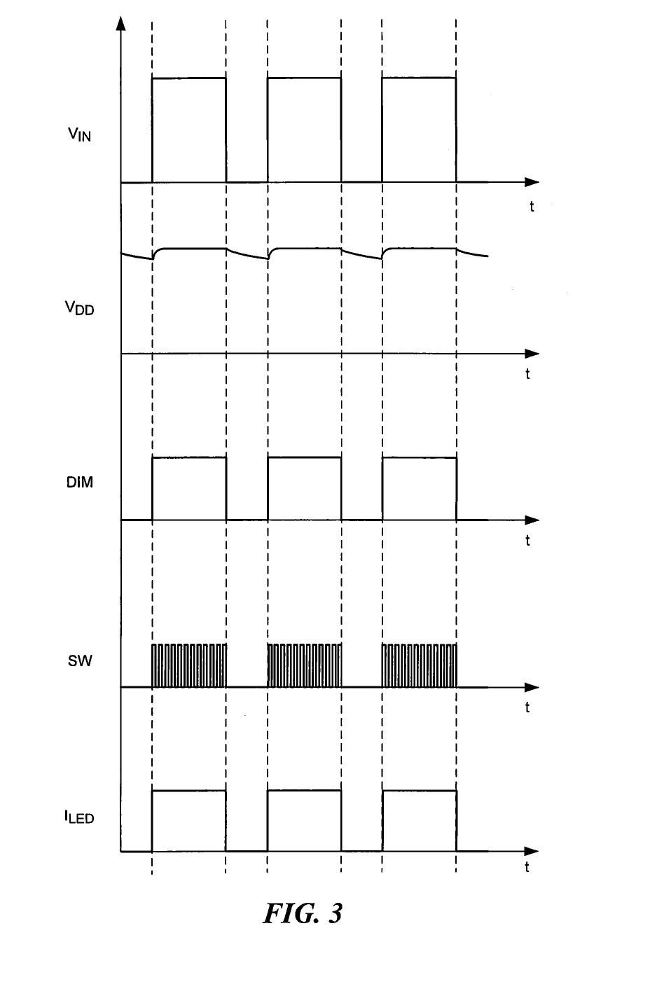

FIG. 3 is a waveform of the LED driver shown in FIG. 2 during operation. The conversion is enabled or disabled by the dimming signal DIM, which is generally synchronous with the pulsed input signal V_{IN}. As a result, the current signal I_{LED} is also a pulse signal having a generally similar pulse width as the pulsed input signal V_{IN}. A small phase offset between them may be introduced by the start-up delay of the power converter 202.

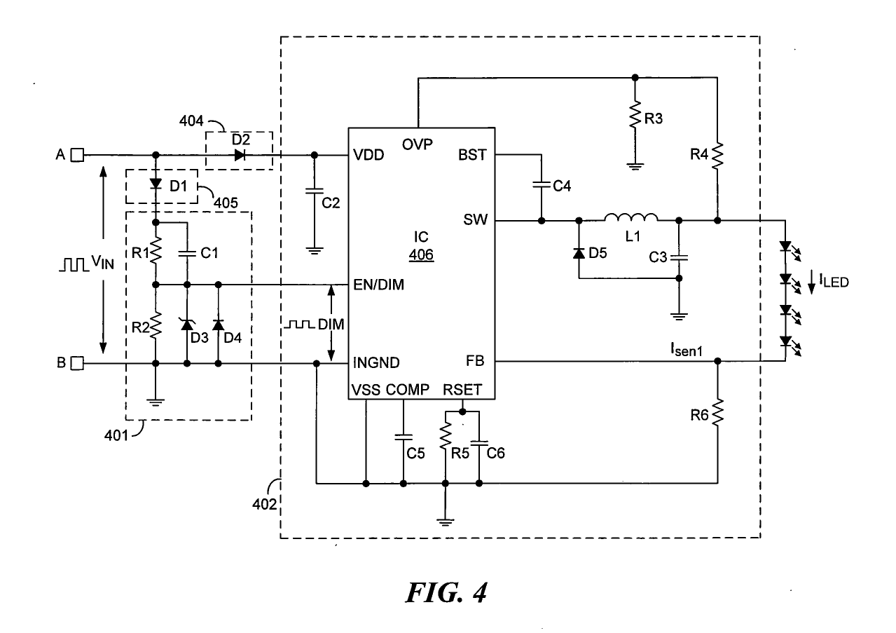

Typically, the power converter 102 can be configured as an integrated circuit with optional external components. FIG. 4 illustrates an LED driver with PWM dimming in accordance with embodiments of the present technology. The dimming signal generator 401, the first polarity protection circuit 404, and the second polarity protection circuit 405 may be generally similar to those shown in FIG. 2. The power converter 402 comprises an IC 406, capacitors C2˜C6, resistors R3˜R6, a diode D5, and an inductor L1. The current I_{LED} flowing through the LEDs is sensed through the resistor R6, and a first current sensing signal Iₛₑₙ₁ is generated accordingly.

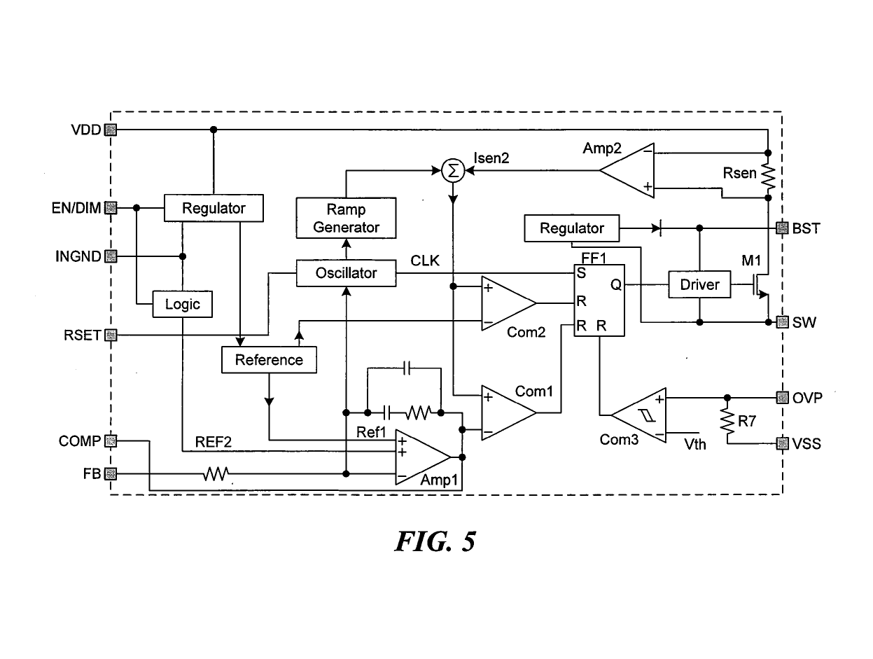

FIG. 5 is a schematic circuit diagram of an IC 406 suitable for use in the LED driver shown in FIG. 4. In the illustrated embodiment, a dual loop, peak current control with fixed frequency is used. An error amplifier AMP1 receives the first current sensing signal Iₛₑₙ₁ through the FB pin, compares it with the smaller one of two reference signals REF1 and REF2, and generates an amplified difference signal accordingly. The current flowing through the switch M1 is sensed through a resistor R_{SEN} and amplified by a current sense amplifier AMP2, and a second current sensing signal Iₛₑₙ₂ is generated accordingly. A slope compensation signal generated by a ramp generator is added to the second current sensing signal Iₛₑₙ₂ to form a sum signal. The sum signal is compared with the output voltage of the error amplifier AMP1 by a comparator COM1, and the comparison result is sent to the reset terminal of a RS flip-flop FF1. A clock signal CLK generated by an oscillator is provided to the set terminal of the RS flip-flop FF1. The RS flip-flop FF1 controls the on and off of the switch M1 through a DRIVER module. The set terminal of the RS flip-flop is rising edge effective, and the reset terminal is high effective. In other embodiments, other suitable control schemes for the IC 406 may also be used.

At the beginning of a cycle, the switch M1 is turned off, and the second current sensing signal Iₛₑₙ₂ is zero. The output voltage of the error amplifier AMP1 is larger than the sum signal, and the output of the comparator COM1 is low. At the rising edge of the clock signal CLK, the RS flip-flop FF1 is set. The switch M1 is turned on, and the sum signal as well as the second current sensing signal Iₛₑₙ₂ is increased. When the sum signal becomes larger than the output voltage of the error amplifier AMP1, the RS flip-flop FF1 is reset and the switch M1 is turned off. This process repeats so the current I_{LED} is regulated and a cycle-by-cycle limit of the current flowing through the switch M1 is provided.

When the dimming signal DIM is high, e.g., larger than 1.4V (or other suitable voltage values), the reference signal REF2 is larger than the reference signal REF1. The IC 406 operates normally and the current I_{LED} is regulated to be a value corresponding to the reference signal REF1. When the dimming signal DIM is low, e.g., smaller than 0.6V, the reference signal REF2 is set to be zero by a LOGIC module. So the current I_{LED} is regulated to be zero through the close-loop control. Under the control of the dimming signal DIM, the current I_{LED} has a generally similar pulse width as the pulsed input signal V_{IN} with only a small offset introduced by the start-up delay of the power converter 402. One of ordinary skill in the art will appreciate the other functions of the IC 406, such as over current protection and over voltage protection, which are not discussed here for brevity.

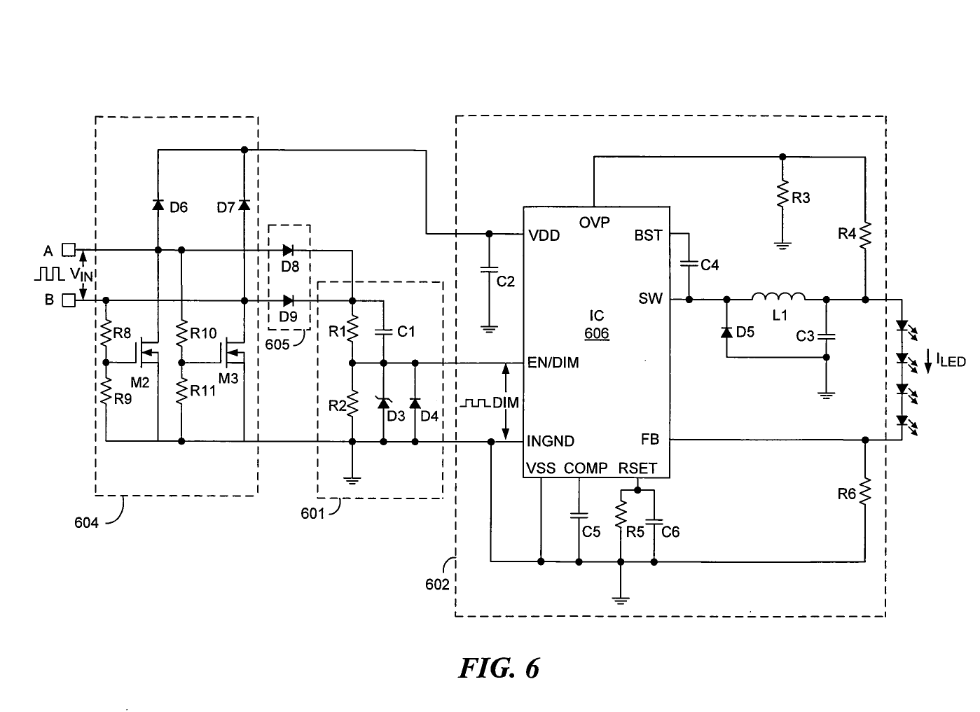

FIG. 6 illustrates an LED driver with PWM dimming in accordance with embodiments of the present technology. The dimming signal generator 601 and the power converter 602 can be generally similar to those shown in FIG. 4. As shown in FIG. 6, the first polarity protection circuit 604 comprises a bridge circuit including diodes D6, D7 and switches M2, M3. The second polarity protection circuit 605 comprises diodes D8 and D9. If the wires are connected in error, the first and second polarity protection circuits 604 and 605 can correct the polarity of the pulsed input signal V_{IN} to allow the LED driver to operate normally.

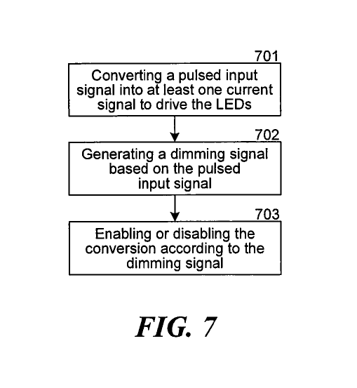

FIG. 7 is a flowchart of an LED driving method with PWM dimming in accordance with embodiments of the present technology. As shown in FIG. 7, the method comprises operations 701˜703. At operation 701, a pulsed input signal is converted into at least one current signal to drive the LEDs. At operation 702, a dimming signal is generated based on the pulsed input signal. The dimming signal may be a PWM signal whose pulse width and frequency are generally similar to those of the pulsed input signal. At operation 703, the conversion is enabled and disabled according to the dimming signal.

From the foregoing, it will be appreciated that specific embodiments of the technology have been described herein for purposes of illustration, but that various modifications may be made without deviating from the technology. Many of the elements of one embodiment may be combined with other embodiments in addition to or in lieu of the elements of the other embodiments. Accordingly, the technology is not limited except as by the appended claims.

I/we claim:

1. A light emitting diode (“LED”) driver, comprising:
two input terminals configured to receive a pulsed input signal;
a dimming signal generator coupled to the two input terminals, the dimming signal generator being configured to generate a dimming signal based on the pulsed input signal; and
a power converter coupled to the two input terminals and to the dimming signal generator, the power converter being configured to perform conversion of the pulsed input signal into at least one current signal to drive an LED, wherein the conversion is enable and disabled by the dimming signal.

2. The LED driver of claim 1 wherein the dimming signal is a PWM signal having a pulse width and a frequency generally similar to those of the pulsed input signal, respectively.

3. The LED driver of claim 1, further comprising a polarity protection circuit coupled between the two input terminals and the power converter.

4. The LED driver of claim 3 wherein the polarity protection circuit comprises a diode or a bridge circuit.

5. The LED driver of claim 1, further comprising a polarity protection circuit coupled between the two input terminals and the dimming signal generator.

6. The LED driver of claim 5 wherein the polarity protection circuit comprises one or two diodes.

7. The LED driver of claim 1 wherein the dimming signal generator comprises a resistor divider comprising a first resistor and a second resistor.

8. The LED driver of claim 7 wherein the dimming signal generator further comprises a capacitor connected to the first resistor in parallel.

9. The LED driver of claim 7 wherein the dimming signal generator further comprises a diode connected to the second resistor in parallel.

10. The LED driver of claim 1 wherein the LED driver is a switch mode DC/DC converter comprising at least one switch, the at least one switch being configured to be turned off when the conversion is disabled.

11. The LED driver of claim 1 wherein a reference used to regulate the at least one current signal is changed by the power converter when the conversion is disabled.

12. An LED driver, comprising:
two input terminals configured to receive a pulsed input signal;
means for generating a dimming signal based on the received pulsed input signal; and
means for performing conversion of the received pulsed input signal into at least one current signal to drive an LED, wherein the conversion is enabled and disabled based on the dimming signal.

13. The LED driver of claim 12 wherein the dimming signal is a PWM signal having a pulse width and a frequency generally similar to those of the pulsed input signal, respectively.

14. The LED driver of claim 12, further comprising:
a first polarity protection circuit coupled between one input terminal and the means for converting; and
a second polarity protection circuit coupled between the other input terminal and the means for generating a dimming signal.

15. The LED driver of claim 14 wherein the first polarity protection circuit comprises a bridge circuit and the second polarity protection circuit comprises two diodes.

16. The LED driver of claim 12 wherein the means for generating a dimming signal comprises:
a resistor divider coupled between the two input terminals, the resistor divider comprises a first resistor and a second resistor;
a capacitor connected to the first resistor in parallel; and
a diode connected to the second resistor in parallel.

17. The LED driver of claim 12 wherein a reference used to regulate the at least one current signal is changed by the means for converting when the conversion is disabled.

18. A method for driving an LED, comprising:
receiving a pulsed input signal;
converting a pulsed input signal into a current signal to drive an LED;
generating a dimming signal based on the pulsed input signal; and
enabling and disabling converting the pulsed input signal according to the dimming signal.

19. The method of claim 18 wherein generating the dimming signal includes generating a PWM signal having a pulse width and a frequency generally similar to those of the pulsed input signal, respectively.

20. The method of claim 18 wherein disabling the conversion comprises changing a reference used to regulate the current signal.
